(19) United States
(12) Patent Application Publication
(10) Pub. No.: US 2007/0299825 A1
(43) Pub. Date: Dec. 27, 2007

(54) Source Code Search Engine

(75) Inventors: Darren Rush, Santa Monica, CA (US); Ankur Bulsara, Beverly Hills, CA (US)

Correspondence Address: PERKINS COIE LLP, P.O. BOX 2168, MENLO PARK, CA, 94026, US

(73) Assignee: KODERS, INC., SANTA MONICA, CA (US)

(21) Appl. No.: 11/663,417

(22) PCT Filed: Sep. 20, 2005
(86) PCT No.: PCT/US05/33624

§ 371 Date: Sep. 11, 2007

Related U.S. Application Data
(60) Provisional application No. 60/612,024, filed on Sep. 22, 2004.

(51) Int. Cl. G06F 17/30

(52) U.S. Cl. 707/3; 707/E17.082

(57) ABSTRACT

In an embodiment, a method of operating a software search engine is provided. The method includes populating a software code database from one or more sources of source code. The method also includes receiving a search query for a software code search engine (525). The method further includes searching the software code database with the search query (530). Moreover, the method includes presenting results of the searching (550). Additionally, the method includes tracking reuse of code portions of the software code database. Also, the method includes reporting on usage of code portions of the software code database (560).

### CLAIM OF PRIORITY

This application claims priority to provisional application Ser. No. 60/612,024, filed Sep. 20, 2004, entitled “Searching for source code files using a system of retrieval, indexing, searching, and ranking sub-systems.” and naming Darren Leslie Rush as inventor. Application No. 60/612,024 is hereby incorporated herein by reference.

### BACKGROUND

Development of software can be a tedious and time-consuming business. Software applications typically all do the same basic manipulations of data. The variation in how those manipulations occur and what the data represents leads to variety in software. Thus, it is not at all unusual to use the same software routines or components in a variety of different applications.

While the same routines may be used, they may have variations which make the individual instances of a routine slightly different. Alternatively, the same routine may be plugged into a different (or related) application when the same type of data is processed. Thus, it may be useful to provide a method of finding existing software code during development of software.

Finding reusable software code is potentially simple. To make it simple, one must have an organized list of software components already in existence and a knowledge of what these components are. However, no typical software engineer has such information for all software the engineer has developed individually. Moreover, groups of software developers generally have only vague knowledge of what members of the group have developed, and little knowledge of what has been developed outside the group. Thus, it may be useful to develop a system allowing organized access to software source code from a variety of software applications or source code repositories. Moreover, it may be useful to categorize or otherwise organize such information, allowing for access to the source code in an efficient manner.

### SUMMARY

Embodiments are described in an illustrative rather than restrictive manner. The invention should not be understood as limited to the embodiments described. Moreover, features of one embodiment may be used in conjunction with other embodiments in which those features are not described. Various features of one embodiment may enhance other embodiments, rather than conflicting with features of other embodiments.

In an embodiment, a method of operating a software search engine is provided. The method includes populating a software code database from one or more sources of source code. The method also includes receiving a search query for a software code search engine. The method further includes searching the software code database with the search query. Moreover, the method includes presenting results of the searching. Additionally, the method includes tracking reuse of code portions of the software code database. Also, the method includes reporting on usage of code portions of the software code database.

In yet another embodiment, a method is provided. The method includes receiving a search query for a software code search engine. The method also includes searching a software code database with the search query. The software code database is populated with source code from one or more sources of source code. The method further includes presenting results of the searching.

In another embodiment, a system is provided. The system includes a software code database. The software code database is populated with source code from one or more sources of source code. The system further includes a search engine coupled to the software code database. The system also includes a user interface coupled to the search engine.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1: Display of an embodiment of the component integrated within an IDE.

FIG. 2: An embodiment of notification of available search results displayed to user after creation of new method.

FIG. 3: An embodiment of a search results summary to (preferably) make it easy for a developer to visually filter results.

FIG. 4A: An embodiment of a detailed code view within a browser can be easily integrated into the current file via copy-and-paste.

FIG. 4B: An embodiment of a detailed code view within an IDE.

FIG. 5A: An embodiment of a process of automatically searching for software code.

FIG. 5B: An embodiment of a process of requesting software code.

FIG. 6A: An embodiment of a process of obtaining software code.

FIG. 6B: An embodiment of a process of searching a database of software code.

FIG. 7: An embodiment of a network which may be used with various other embodiments.

FIG. 8: An embodiment of a computer or machine which may be used with various other embodiments.

FIG. 9: An embodiment of a medium which may be used in conjunction with an application, for example.

FIG. 10: An alternate embodiment of a machine-readable medium is provided.

FIG. 11: An embodiment of a process of operating a code search engine.

FIG. 12: An embodiment of a code search engine system.

FIG. 13: Another embodiment of a code search engine system.

FIG. 14: An embodiment of a code search user interface.

FIG. 15: The embodiment of FIG. 14 showing search results.

FIG. 16: An embodiment of a user interface for a code portion.

### DETAILED DESCRIPTION

A system, method and apparatus is provided for a source code search engine. In many embodiments, a single search interface to multiple source code repositories or storage systems is provided. The search interface may search source code on a variety of levels of detail. The single search interface may further rank the source code based on usage and reuse. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

Preferably, one or more of the following features is provided. General source code searching (such as full-text searching) is one such feature. Syntax level source code searching may also be useful—searching based on grammatical patterns of source code, rather than exact text matches. Similarly, searching based on associated metadata may be useful. Moreover, providing feedback about what code is useful based on tracking of reuse statistics for code portions may be useful. In order to provide such feedback, tracking of reuse must occur, too.

In an embodiment, a method of operating a software search engine is provided. The method includes populating a software code database from one or more sources of source code. The method also includes receiving a search query for a software code search engine. The method further includes searching the software code database with the search query. Moreover, the method includes presenting results of the searching. Additionally, the method includes tracking reuse of code portions of the software code database. Also, the method includes reporting on usage of code portions of the software code database.

In yet another embodiment, a method is provided. The method includes receiving a search query for a software code search engine. The method also includes searching a software code database with the search query. The software code database is populated with source code from one or more sources of source code. The method further includes presenting results of the searching.

In another embodiment, a system is provided. The system includes a software code database. The software code database is populated with source code from one or more sources of source code. The system further includes a search engine coupled to the software code database. The system also includes a user interface coupled to the search engine.

A search engine for searching the contents of software source code files found in local or remote source code repositories is provided in one embodiment. The search engine connects to each repository using the appropriate protocol and copies versions of the project source code files to a local copy. An indexing system indexes each file to extract relevant meta-data and create statistics that can later be used as criteria for searches. A search system that allows users or other systems (computers) to search the indexes for files that contain the specified search criteria. A ranking system that presents matching search results in a most-relevant to least-relevant order may also be employed.

Embodiments relate generally to construction of search engines for source code, and some embodiments relate more particularly to search engines that index source code to extract embedded meta data and rank results in an intelligent way that is most relevant to the user.

Various features may be incorporated into a variety of embodiments of source code search engines and related software. An initial discussion of an embodiment of a source code search engine is provided, along with various embodiments which are illustrated in the figures and described. Features from one embodiment may be integrated into other embodiments, as the various features generally enhance, rather than conflict with, features of other embodiments.

In addition to a full-text analysis of each file, the indexing engine may also analyze each file based on the programming language it is written in—essentially parsing and compiling the file to extract its programmatic definition and resolving references to external components. This semantic representation of the file is used to assist users in understanding the higher-level functions provided by the source code, and to enable the system to cross reference entities in the file across files and projects.

After conducting a search, a user is presented with summaries of files with matching results. In some embodiments, clicking a file from the list of results displays that file contents in a code-colored fashion—and also highlights the search terms. From this code view, the user can click a link to download the entire file or copy and past portions of the file into their application.

When the user downloads the file, the system registers this as an instance of reuse and correlates the reuse with the previous search conducted by the user. When a user selects a portion of the contents of the file in order to cut and paste, the system detects this and presents the user with a dialog box confirming that they wish to copy part of the file. The user can choose OK, Cancel or Yes, No. choosing No or Cancel will disable the copy and paste function. Clicking Yes, or OK, will enable the copy and paste function and register an instance of reuse on the system. Again this reuse will be correlated to the previous search conducted by the user.

By indexing and parsing the code for each file, one may identify the definitive entities and members referenced by each statement in the code. This information allows developers to easily find the location where an entity is defined, and to identify other locations where the entity is referenced. While this functionality is generally available in IDE applications within the scope of a project, one can apply this principle to all projects that have been indexed, whether from internal version control systems, internal file systems, or external sources of software code.

A side effect of this enables keeping a reference count for each entity. One may sum these reference counts at the file level and for the purpose of scoring results, use this reference count to determine which files are likely more reusable matches than other files.

The scoring mechanism uses a formula to calculate the score for each file matching a search. The score is used to sort the display of resulting files to the end user.

In one approach, in general, files will score higher if:

1. They have been reused by developers previously

2. They contain the definition for an entity which is referenced by other projects

3. They have a high frequency of matching terms specified in the search

The following terms may be used in one approach:

ReuseScore—the number of times a file has been downloaded or a portion of the file has been copied.

ReferencedEntityCount—the number of references to the entities in this file from other files within the project and within the entire index.

WordFrequencyCount—the number of times a search term is found divided by the number of words in the file*100;
Score=((ReuseCount>0)*10000+ReuseCount)+((ReferencedEntityCount>0)*5000+ReferencedEntityCount)+WordFrequencyCount

This composite formula, in this particular approach, ensures that files that have been reused are displayed first, followed by files that have many external references to the entities defined within, followed by files that have a high frequency of the search terms contained within the content.

Other approaches to a score or ranking of source code may also be useful. Within the approaches outlined above, different formulas may be used under various circumstances.

In addition to the basic lines-of-code analysis for source code files, the number of lines of code may be aggregated at the project level to estimate the approximate value of the project. Using generally accepted industry assumptions, the value of a project can be calculated from the following formula:
Project Cost=[TLOC]/1000*[EKLOC]*[FP]*[LC]

Where

TLOC=Total Lines of Code for entire project

EKLOC=Number of person-months to write 1000 lines of code

FP=% of functionality needed by the developer who will use the project

LC=Labor Cost for 1 developer for 1 month (average)

From the project view screen the user can adjust some of the variables to their liking, then click Recalculate to see the new Project Cost. This is an estimate of the cost that would be incurred if a development team were to build the equivalent functionality themselves.

In addition to providing a current view of a software project, the system can also provide historical analysis by using stored snapshots of the project at previous points in time. Specifically, version control systems which an application connects to store all the past versions of each file in the project. Using the indexing system against this historical data can provide new analysis. This may include project and file line counts over time—users can see how the project grew over by plotting the total lines of code for each version in the version control system. This data can be useful for understanding project progress. (Sometimes referred to as velocity) This data may also be broken out by developer. This analysis can be used to see how individual developers contributed to the project over time.

Since the system often knows the users who both created and are reusing a particular file, the system is potentially capable of sending notifications to both parties when the file has changed. There are at least two scenarios when this might be useful. One, the author(s) updates the file with bug fixes. The system notifies all users who have reused the file that changes have occurred, and gives them a summary of the changes since they reused the file. Two, a developer reuses the file and makes changes that the original author could benefit from. With the (reuse) users's permission, the system can notify the author(s) of the changes that have been made so the author can choose to integrate the changes back into the main project.

A set of features of an embodiment has been described. Various features as described below may be incorporated into such an embodiment, or other embodiments. Such features may include periodically taking local snapshots of software projects from internet or other source locations. Indexing the source files to identify embedded meta-data and statistical information may then occur. Such information may include the programming language(s) for the file; number of lines of code, comments, mixed code and comments, and blank lines; length of the code; length of the comments; any embedded licenses such as GPL, LGPL; an xml fragment, embedded in the comments of the file—or in an ancillary file which describe the source file; and keywords used in the file and their frequency.

The system may then allow users to search the created indexes using any of the indexed data. In response, the system may present the search results using a scoring mechanism in a most-relevant to least relevant manner. Various scoring mechanisms may be used, including highest total uses of keywords indicated in search; DOCS score: ratio of comments stream length to code stream length; or File Duplicity Score: the number of times this file is referenced in other projects, for example.

The system may also track reuse of code in one or more ways. This may include tracking all instances of a user reusing or re-purposing a file. This may also include correlating searches with the results that were found to be useful for that particular search. Moreover, this may include notifying users who have reused a file of new changes and/or notifying the original author(s) of changes to a file made by a developer who is reusing the file.

Similarly, reporting on system usage may occur. This may involve providing analysis of searches and/or analysis of reuse. This may also involve providing search and reuse analysis by demographic or community group, for example.

Other embodiments may use a variety of techniques to achieve similar results. A method of connecting to source code repositories and downloading updates of project source code files can be involved. This may include enumerating a list of source code repositories containing connection and authentication information. This may further include connecting to each repository using the proper protocol. Similarly, this may involve issuing commands to download the project to a local copy. Alternatively, this may involve issuing commands to ensure that the local source code project files are up-to-date with the files in the remote repository (synchronizing, for example).

A method of indexing each of the local copies of the source code project files may also be involved. Such a method may include determining the type of source code contained in each file by utilizing the file extension of the file to determine its type. This may also include indexing the file using the appropriate indexing system to determine if it contains relevant code and comment sections. Moreover, this may include using a custom indexing process for each type of source code file.

The method of indexing generally produces an index. In some instances, the index produced contains a list of keywords found in the source code file with a corresponding count of the frequency of each keyword in the file. This may be accomplished by parsing the file using a regular expression system to find matches of each word using a pattern matching expression that is specific to the syntax of the particular programming language used in the file. This may then proceed by maintaining a table of words and their frequency in the file, adding each new word found to the table with a frequency count of 1, and incrementing the frequency count in the word table for each additional time the word is found in the file contents.

Alternatively, the index may contain: total number of lines of text in the file, total number of lines containing source code in the file, total number of lines containing comments in the file, total number of lines containing both source code and comments (labeled as mixed), and the total number of lines that are empty or blank in the file. Each of the aforementioned statistics may be determined by parsing the file using a regular expression pattern matching system with match patterns specific to the programming language found in the file. Such patterns may be determined for each language by the syntax specification for the language.

Similarly, the index produced may contain the total length of the source code in the file. This may be determined by removing all blank lines, comments, and also removing all formatting specific information in the file as required by the syntax specification for the specific programming language. In many programming languages, formatting specific information may include: whitespace characters such as a space character (ASCII 32) or a tab character (ASCII 9). The index may also include the total length of the comments in the file, determined by removing all source code in the file and removing all formatting specific information in the file. Calculating a score (called DOCS herein) based on the ratio of
(Length of Comments)/(Length of Source Code)
may then occur.

An index may also include primary programming languages used in the file. Similarly, an index may contain the name of a license information contained in the file. This may be accomplished by searching the file for text that is known to be a part of well known licenses, and comparing the found text to the contents of the well known licenses, determining the best match based on keyword frequency and uniqueness of terms found in the text, for example. Additionally, the index may contain the name of any copyright information contained in the file. Such information may be found by searching the file comments for strings containing the term copyright or the copyright© character.

A hashing algorithm may be used to produce a value based on the contents of the file that when compared to a hashcode produced by the contents of another file with identical contents—would be equal. Herein this value is known as the FileHashCode. This may preferably be accomplished using an invertable hash code.

The index may also contain the contents of an XML which provides author specific information about the file. Such information may be found by searching the comments of the file for appropriate starting <xml> and the corresponding ending </xml> tag. This may also involve removing any illegal comment characters from the body between the starting and ending tags. Alternatively, the actual xml tag containing the additional file information may be any of a subset of tags defined in public documents.

In some embodiments, a method for embedding file or project specific information directly in a source code file is provided. The method includes building an XML tag set providing the specific information. The method also includes embedding the XML tag set in the comments of a source code file. Alternatively, the method includes embedding a link to an ancillary file containing the XML tag set in the comments of the source code file. Similarly, in some embodiments, a method of allowing users to search the indexes to identify files that meet their search criteria by keyword, project, repository, license, programming language, or link to other projects may be provided.

A method of scoring results of search results to display files in a most relevant to least relevant fashion may also be provided in some embodiments. In some embodiments, the user can choose to sort results by a preferred scoring mechanism. This scoring method may be the DOCS value mentioned previously. Alternatively, this scoring method may be a Word Frequency Score (WFS) calculated as:
Sum(Word Frequency of each Search term in the Resulting file)
Similarly, the scoring method may be a File Reuse Score (FRS)
FRS=sum(Files in the Index with same FileHashcode as resultant file)

In various embodiments integration with an IDE may be desirable, and such implementations may include some or all of the following features:
Integrating with a text editor (IDE) to detect when software developers create or modify structural elements of a software application such as namespaces, classes, interfaces, functions, methods, properties or fields.
Performing a background search when these elements are created or modified against one or more external source code databases in order to identify existing software source code that is similar to or related to the defined element.
Indicating to the developer through visual or other means the number and nature of matching results.
Allowing the developer to easily access the results by clicking a message or typing a special keyboard combination.
Presenting the results in such a way that they may be easily copied and pasted from the results into the developers IDE.
Collecting statistics on searches and reused source code results in order to iteratively improve search results over time.

Embodiments relate generally to the construction of software components which enable text-editor applications to make recommendations to the user regarding the integration of external content which may be reusable in the document currently being developed, and more specifically to the application of such as system to the domain of software development.

Features of some embodiments include a software component that integrates with text editors designed specifically for software development—also known as integrated development environments (IDEs). The software component or module may be able to detect when a developer is creating or modifying defining elements of a software application such as namespaces, classes, interfaces, functions, methods, properties or fields. A related component may implement a system of searching one or more external databases containing source code to identify code that is similar to or related to the element that has been defined. This may work with a component implementing a system of notifying the developer of the number and nature of results which are found and a system of displaying results that enables the developer to easily copy-and-paste results into the application currently being developed. Searching may involve a system of indexing source code so that searching for similar or related source code can be performed quickly. This may also involve a system of recording searches and the results selected by developers in order to iteratively improve the ranking and display order of search results in the future.

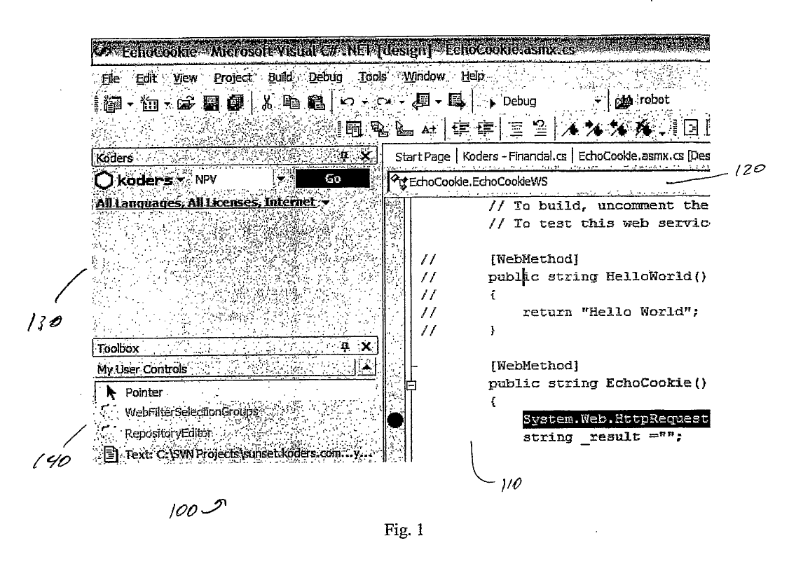

Discussion of an embodiment with respect to its user interface may provide further insights into how a code search engine may be integrated with an IDE (integrated development environment). FIG. 1 illustrates display of an embodiment of a code search component integrated within an IDE. Interface 100 includes classic elements of an IDE along with a code search engine. Window 110 provides an editing environment for code. Location 120 provides an indication of what software code is currently being edited. Code search interface 130 provides an interface allowing for selection of search parameters. Codespace display 140 provides an illustration of the overall codespace in which development is occurring, with an indication of the context of the current code of window 110. In the illustration of FIG. 1, no search has occurred, and parameters allowing for search of all types of code are selected.

Source code comes in a variety of shapes, sizes and forms. Various portions of source code may be referred to as systems, applications, libraries, components, modules, object, classes, methods, routines, procedures, functions, or snippets, for example. Any one or more of these portions may be suitable for detection, or as a result of a search in various embodiments. Also, note that reuse of other types of computer data, such as general text for example, may be similarly handled with a search engine and document management system, for example.

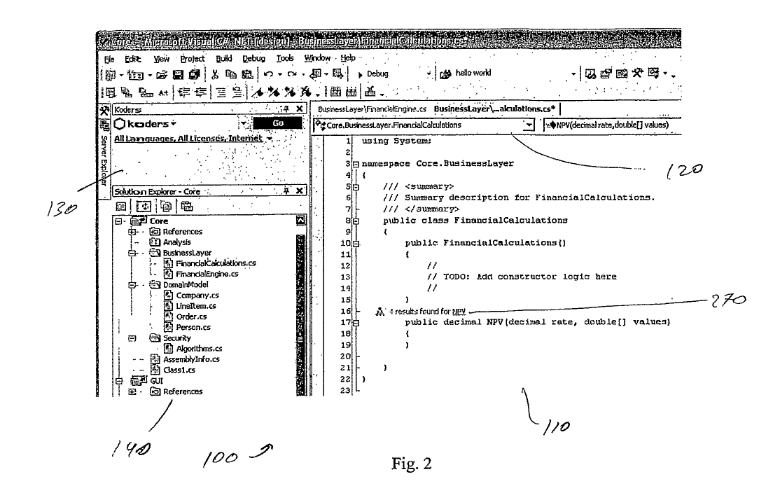

In response to either a request or changes in source code, a search may be initiated. Turning to FIG. 2, an embodiment of notification of available search results displayed to a user after creation of new method is displayed. Search notification icon 270 indicates that a potential match has been found for code currently being developed in window 110. The search is based on characteristics of code displayed in code display 110 of FIG. 1, and occurs in a background process while editing occurs. Searching may be triggered based on detection of new software code, or of a change in API of an existing method, object, function or other portion of code. Clicking on icon 270 leads to a display of software code which were found by the search.

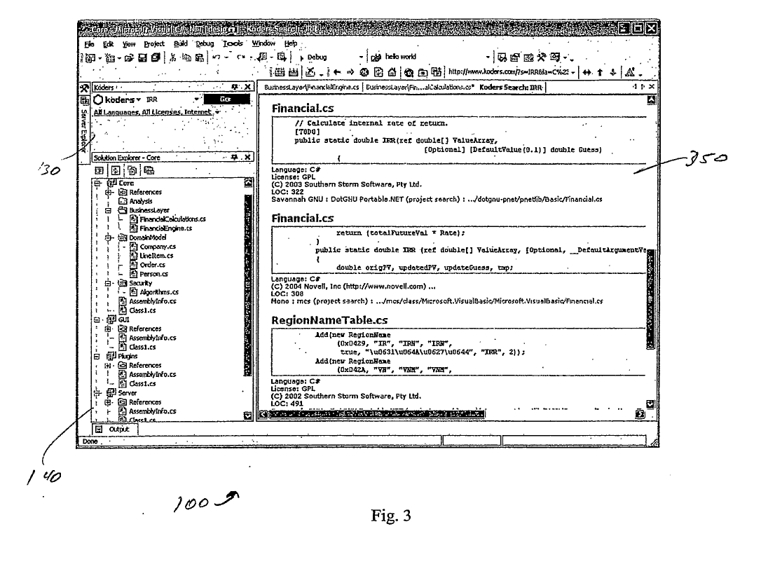

Alternatively, a listing of a variety of results may be provided. FIG. 3 provides an embodiment of a search results summary to (preferably) make it easy for a developer to visually filter results. Instead of showing all software code, a summary of results may be provided, as illustrated in display window 350. Each code portion is displayed with its API and information about where it may be found (and potentially what licensing restrictions it carries).

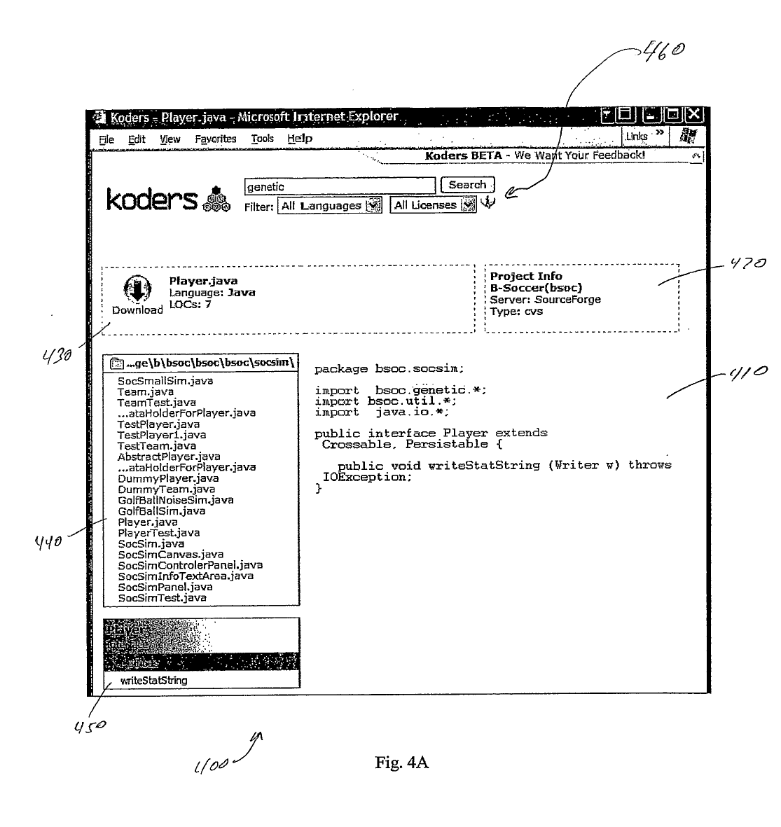

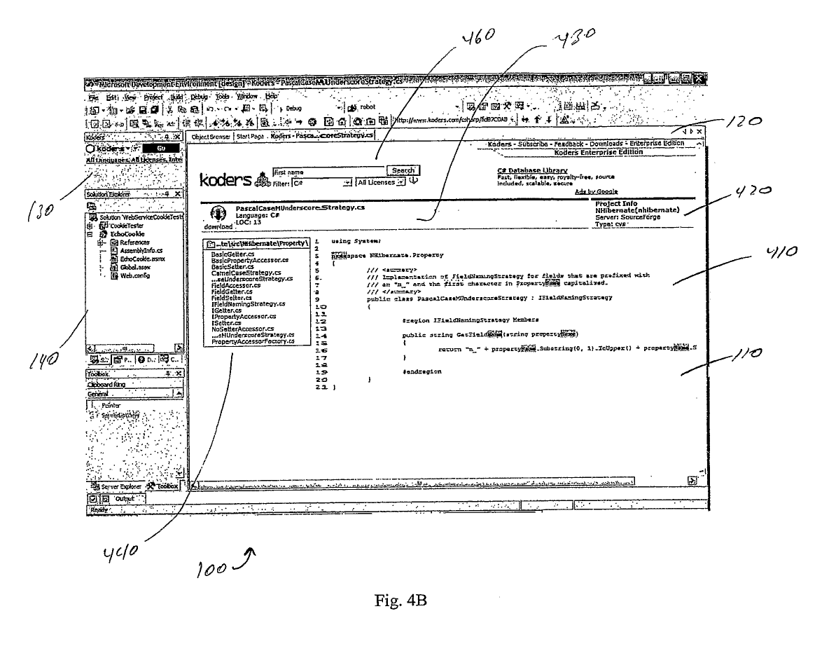

A specific result may be further provided in a separate window. FIG. 4A illustrates an embodiment of a detailed code view within a browser which can be easily integrated into the current file via copy-and-paste. Interface 400 may be viewed in a browser such as Internet Explorer of Microsoft or Firefox, for example. Code 410 is the actual code of the portion. Project information 420 indicates where the code originated, and potentially what licensing restrictions are carried with the code. Language information 430 indicates what language the code is in, and potentially what requirements the code has for integration (e.g. language version, specialized libraries, etc.) Context information 440 indicates what other modules are available along with the instant module. Interface data 450 provides information about the API of the instant module. Also provided is an opportunity to refine a search in search interface 460, including specification of languages, licenses, and keywords, for example.

FIG. 4B illustrates a similar interface to that of FIG. 4A as may be incorporated into a development environment (an IDE for example). Thus, the information about what software code is available may be displayed in conjunction with context information about development of a project. Material may be copy-and-pasted or otherwise integrated into the project.

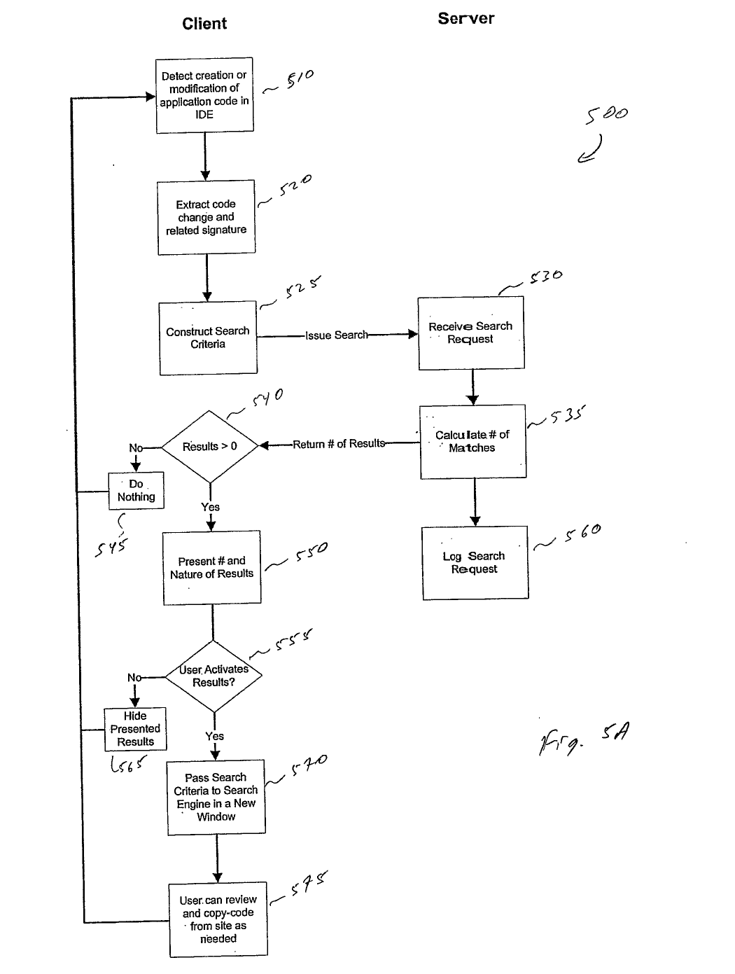

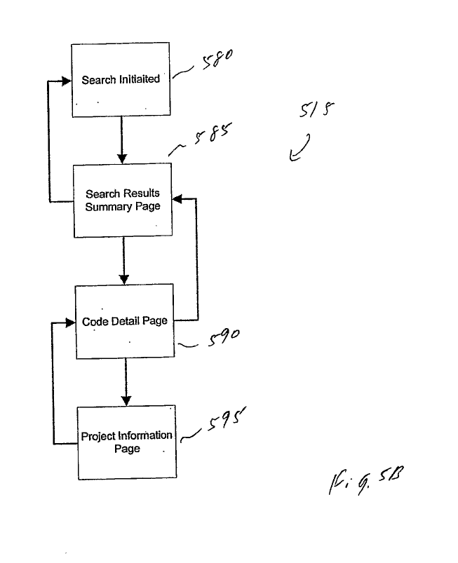

A search may be initiated and performed either in reaction to writing code or responsive to a request. FIG. 5A provides an embodiment of a process of requesting software code. Process (method) 500 and other processes of this document are implemented as a set of modules, which may be process modules or operations, software modules with associated functions or effects, hardware modules designed to fulfill the process operations, or some combination of the various types of modules, for example. The modules of process 500 and other processes described herein may be rearranged, such as in a parallel or serial fashion, and may be reordered, combined, or subdivided in various embodiments.

A search request may be originated when a change is detected in a software module at module 510. Such a change may involve a change in parameters, editing the software code, or other changes discussed elsewhere in this document. Code information (search parameters) is extracted at module 520. Thus, an API or functions of software code may be extracted as a signature, for example. A search query or set of criteria are constructed at module 525 for submission to a search facility.

The search query is issued, and at module 530, the search request is received and executed. This may involve various search algorithms and database queries to find matches of varying quality. At module 535, the number of matches received is calculated and passed back to a client issuing the search query. At module 540, a determination is made as to how many results were found. If no results were found, the search is ignored at module 545 (presumably returning to module 510 to await detection of another change). Results of the search (if they exist) are presented to the user at module 550. A determination is then made at module 555 as to whether the user is activating (e.g. accessing) the search results. If not, at module 565, the results are hidden. Note that the results may be stored in a circular queue or other storage mechanism (data structure), allowing a user to backtrack after ignoring an initial notification to see what a search turned up. This allows for user second-guessing after, for example, realizing the software code may take more work than expected or remembering a prior piece of code which may be useful, for example.

If the search results are activated, in one embodiment, the search criteria and results are passed to a new window for review at module 570. At module 575, the user may then review the specifics of results, and copy-and-paste or otherwise integrate code into the present project, for example. Also, separate and apart from use of the search, statistics resulting from the search and user use of the search results may be stored at module 560, either in conjunction with the searches or after search and use of search results, for example. These statistics may simply be server-based (potentially only including search queries and results) or may be more inclusive.

Alternatively, a search may be initiated by a user submission at a webpage or through a toolbar, for example. FIG. 5B illustrates a user-initiated search process. Process 515 includes search initiation, presenting a results summary page, providing detailed information, and returning to a project page.

Process 515 begins with initiation of a search at module 580. This may involve providing various search criteria, for example. At module 585, search results are provided responsive to the search criteria. Specific software code may be displayed at module 590. The user may also review project information (of the project from which the source came) at module 595, and may find other code to integrate, for example.

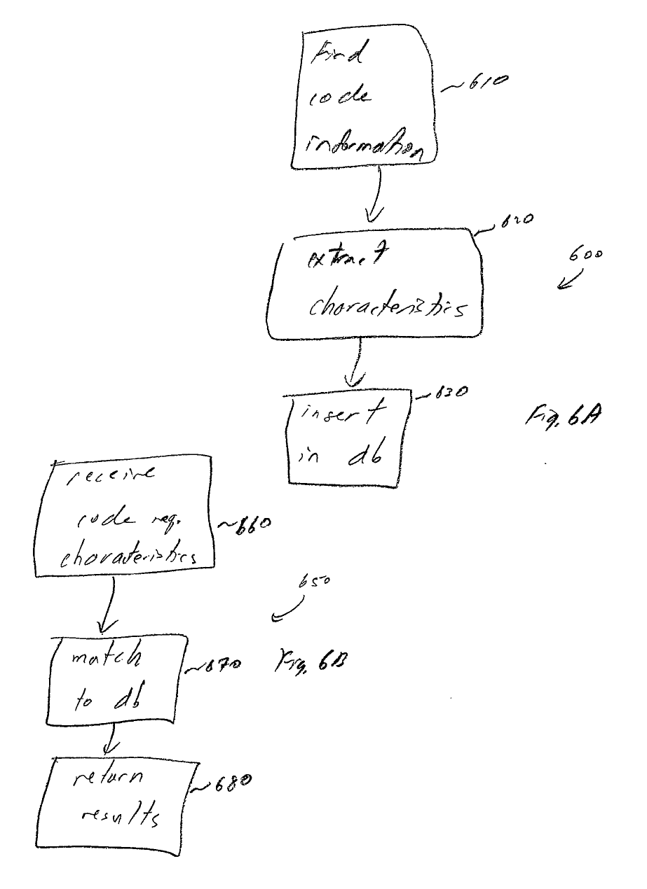

Software code may be collected in a variety of ways. FIG. 6A provides an embodiment of a process of obtaining software code. Process 600 includes finding code information at module 610. This may include interfacing with a version control system or revision control system. This may also include code submissions made by developers, for example. For internal systems, specific version control systems may be used. For other systems, public sources of code can be used. Characteristics of the code are extracted at module 620, including information such as API, language, license, etc. This information is inserted into a database at module 630, to allow for rapid searching.

With information about software code collected, the software code may then be searched. FIG. 6B provides an embodiment of a process of searching a database of software code. Process 650 includes receiving code request characteristics, such as language, function, API, etc. at module 660. This further includes matching such characteristics to information in a database at module 670 (such as through database requests, for example). Results are then returned at module 680.

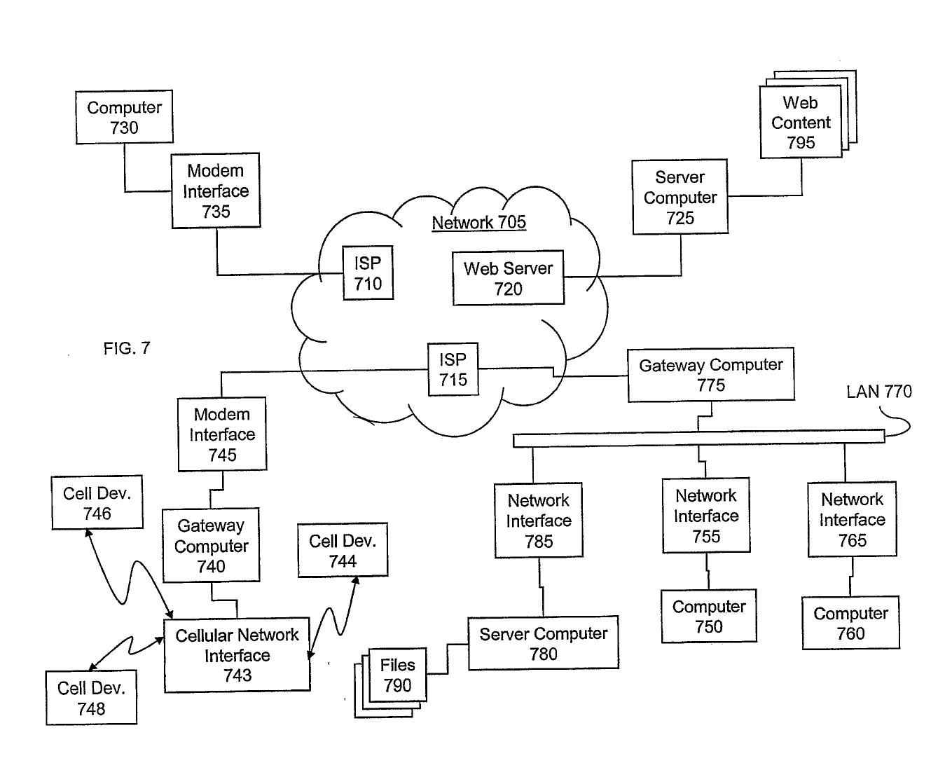

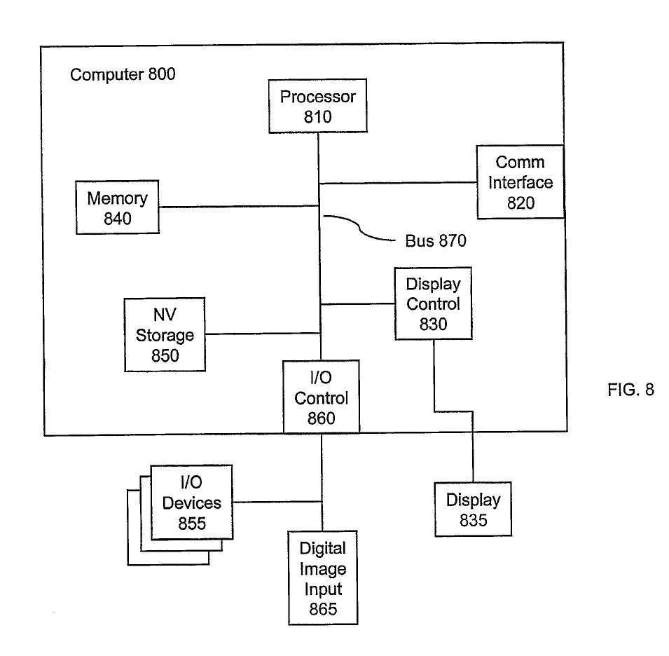

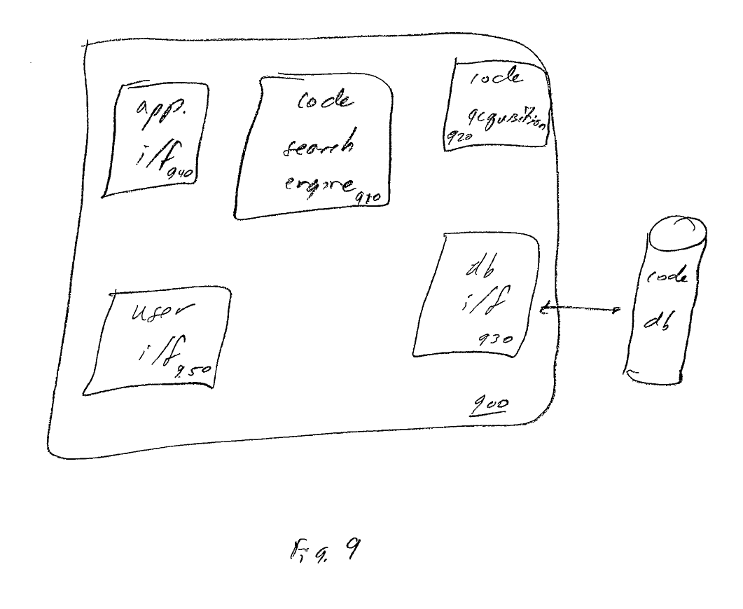

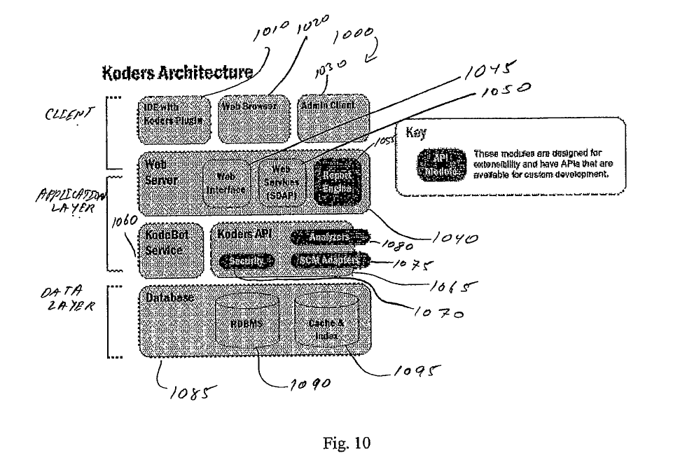

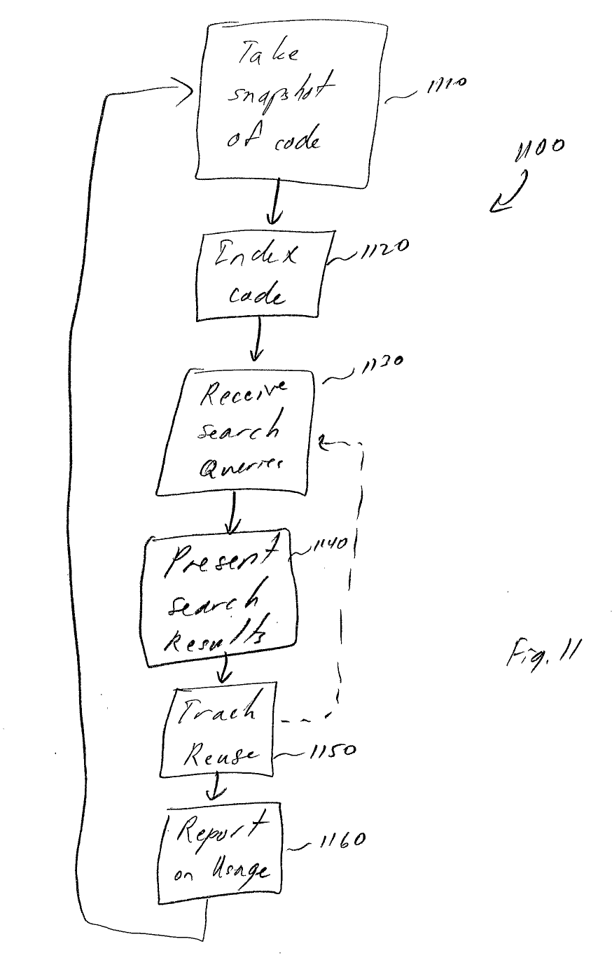

The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular network and related cellular devices. The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example. Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device. Such a device can be used to perform many functions depending on implementation, such as telephone communications, two-way pager communications, personal organizing, or similar functions. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel pentium microprocessor or Motorola power PC microprocessor, a Texas Instruments digital signal processor, or some combination of the two types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display-i/o controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

The search engine and application interface may be embodied in a medium in some embodiments. FIG. 9 illustrates an embodiment of a medium which may be used in conjunction with an application, for example. Medium 900 includes a code search engine, code acquisition module, database interface, user interface and application interface. Code search engine 910 may interact with the user interfaces and the database interface to facilitate searching for software code. Acquisition module 920 may interface with code sources such as revision control systems, and accept code submissions. Database interface 930 may accept database entries and requests for information from a database 960. Application interface 940 may work with an application to allow search requests to search engine 910, such as by providing a plug-in, toolbar, or other interface. User interface 950 may similarly allow for search requests or code submission through the web (separate from an IDE).

Another embodiment of a machine-readable medium may be used to implement the methods and systems of various embodiments. A source code search system as embodied in medium 1000 may be implemented as three primary layers, each potentially containing several components. These components may include a source code database index (index), a source code crawler (kodebot), a web application front-end (web interface), and desktop client plugins (plugins).

The index may contain two primary schemas—a registry of repositories and projects—essentially a map of internal source code databases, as well as a high-performance searchable source code cache (implemented as cache 1095 in this embodiment). The project registry, system statistics and other metadata may be maintained in an SQL Server (a relational database 1090) for example. Database 1085 thus includes the database 1090 and search portions 1095. Alternate databases options are also available.

The kodebot 1060 may be implemented as a service process which synchronizes the index with external version control systems (or software configuration management systems (SCMs) for example) within an organization, for example. Koders API 1065 may allow for interaction with other software services and data repositories, for example. Thus, SCM adapter 1075 may allow for an interface with SCMs, analyzers 1080 may be customized to extract signature information from software code, and security API 1070 may be used to program security measures for the system 1000. The web server 1045 may allow users to search the index 1095, view related reports, and update the project registry, for example. This may occur in part through use of web interface 1045, web services 1050, and report engine 1055, for example.

The admin client 1030 (sometimes referred to as the kodebot client) may serve as the administrative interface for maintenance of system configuration, security policy, and the project registry, for example. The plugins 1010 may be optional components of the system that allow developers to search a code server and database within the context of a development environment, for example. Currently, plugins may be used with popular applications such as Visual Studio .NET, Eclipse and Firefox, for example. Developers can potentially download and install these components at any time. Web browser 1020 may be a conventional web browser such as Internet Explorer or Firefox, for example.

In various embodiments, methods and apparatus may be provided, and a further discussion of various features in some embodiments may be illustrative. An embodiment may include a method of notifying software developers of existing reusable source code from external databases which may be integrated into their current project. Similarly, an embodiment may include a method of integrating a software component with a text-editor or integrated development environment (IDE).

Additionally, embodiments may include a method for detecting each time a developer is creating or modifying structural elements of a source code file from within a text editor (IDE). This method may include integrating with the IDE using available APIs and methods to capture developer keyboard sequences and IDE-specific events. The method may further include detecting the programming language the developer is writing source code in either by analysis of the file, or via API methods provided by the IDE. The method may also include detecting the creation or modification of classes, interfaces, functions, methods, properties or fields by analyzing keyboard sequences for syntax used to define such elements as specified by the grammar of the particular programming language. The method may include extracting the element name and related signature information if available.

Moreover, embodiments may include a method of constructing a search query from the programming language and element name extracted. The method may involve signature information of the defining element as a search parameter. The method may further include specifying the breadth of desired results the developer would like to receive. Such specification may include ‘exact matches’, ‘better matches’, or ‘more matches’ for example.

In issuing a search query to one or more external source code databases, the search mechanism may be implemented to avoid interrupting or distracting the user while the search is being issued and a response returned. Similarly, the search mechanism may provide a response containing the number of matching results and textual indication of the nature of those results. Likewise, the method can be issued (a search can be issued) to remotely located source code databases connected to the computer using a protocol. For example, the method may use HTTP/SOAP for the network protocol

Additionally, embodiments may implement a method of notifying the developer through visual or other means the number and nature of matching results. This may include an audible notification. Such a notification need not require the developer to stop typing, or otherwise disrupt their work. Moreover, the method may involve hiding the visual notification if the user does not activate the link after a fixed or predetermined number of seconds. The developer may easily access search results, such as by allowing the developer to click the message to view the results or allowing the developer to type a specific keyboard combination to view the results.

Embodiments may further include a method of presenting the results in such a way that they may be easily copy-and-pasted from the results into the developers IDE. For example, this method may include opening a new web browser window within the IDE. The method may also include constructing a URL which contains the database location and search criteria. The method may further include passing the URL to the newly opened web browser window. The method may also include displaying the resulting results in the web browser window. The method may allow the developer to navigate as needed. Likewise, the method may allow the developer to copy source code off of pages displayed in the web browser window.

Embodiments of methods may further incorporate user preferences to improve search accuracy. This may involve allowing a user to create a list of certain terms which will not be searched. Similarly, the method may be implemented to remember each search conducted and not re-issue repeat searches during the time the IDE is active

Likewise, embodiments may include a method of indexing source code so that it may be searched quickly. The method may include a method of (or protocol for) specifying the location of source code projects. The method may also involve a method of retrieving and analyzing source code. The method may also include a method of compiling source code into searchable indexes. Likewise, the method may include a method of exposing a search interface to remote clients over the network that utilizes protocols such as HTTP/SOAP.

Along with the various processes of retrieving source code, embodiments may include a method of recording statistics. This may involve recording each search, recording when a developer chooses to download a source code file, and a method of recording when a user copies source code from a web page, for example. The method of recording copying of source code may involve embedding special code in the web page to detect mouse events, detecting when a user starts to copy by clicking and holding a mouse button down, detecting when the user has released the mouse button, and sending a message to the server indicating that a copy and paste event has occurred. Recording statistics may also involve recording a correlation between a search and the result(s) that was downloaded or copied by the developer.

With statistics recorded, embodiments may implement a method of applying statistics to improve search results over time. This method may include assigning search results files a score. The method may further include increasing the default score for files based on how frequently they are downloaded or copied by developers. Also, the method may involve further increasing the score for a particular file when it has been shown to be downloaded or copied more than once by developers issuing the same search. Likewise, the method may include sorting search results so that matching resultant files shown in order of score, highest score first, and lowest score last.

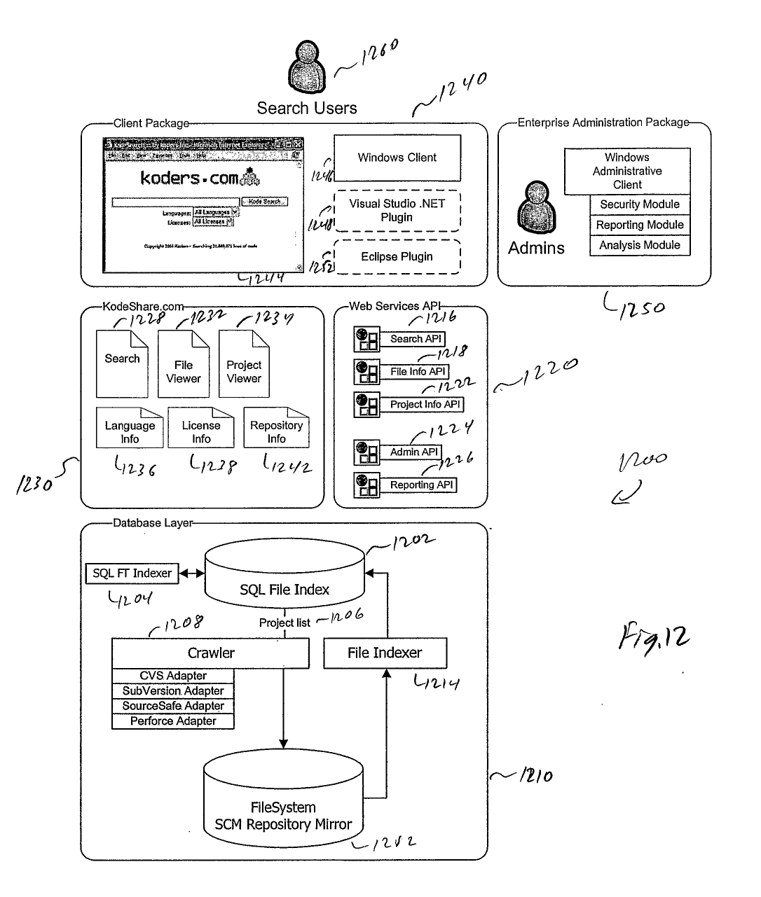

Further illustration of an embodiment in a standalone or web-based form may be useful. Note that whether an embodiment is implemented as a standalone application, web-based application, or as part of a development environment or application, functionality from the various embodiments may be used. FIG. 11 illustrates an embodiment of a process of operating a code search engine. Process 1100 includes taking a snapshot of source code, indexing the source code, receiving search requests, presenting search results, tracking reuse of code, and reporting on usage of code.

Process 1100 initiates with a snapshot of source code at module 1110. This may involve retrieving code from a revision control system, a public software code repository, or some combination of the two. The snapshot of source code is indexed at module 1120, providing for high-speed search and location of source code portions.

At module 1130, a request or query for source code is received. At module 1140, the index of source code is searched and results are presented. In conjunction with presentation of results, reuse of code is tracked at module 1150, such as by accumulating the number of times source code portions are indexed in results, or are actually used by a user. At module 1160, utilization and reuse are reported to a user or administrator.

Note that the process may involve loops of various modules. For example, repeated queries and results may involve a loop of modules 1130, 1140 and 1150 Likewise, after a report on usage, or even before such a report, the process may loop back to module 1110 for an updated snapshot of source code.

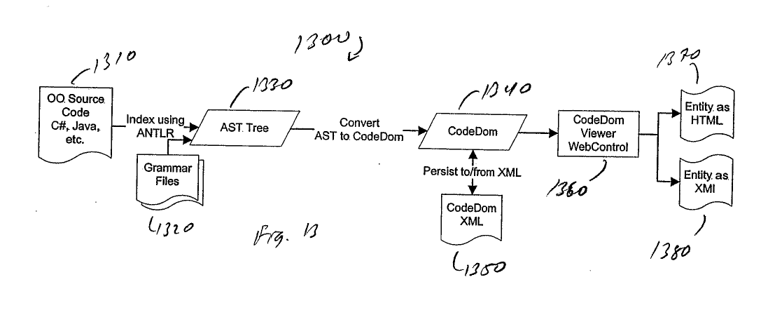

Various embodiments of a source code search system may implement the method of FIG. 11 or a similar method. FIG. 12 illustrates an embodiment of a code search engine system. System 1200 includes a database layer, web services API, client interface, administrator interface, and a website engine.

Database layer 1210 includes a SQL index 1202, indexer 1204, project list 1206 (a list of software projects in the repository), crawler 1208 (a software robot which can find data remotely), repository 1212 and repository indexer 1214. Index 1202 and repository 1212 provide the main sources of data for the system, with the index 1202 providing a fast access system and repository 1212 providing comprehensive data.

Website engine 1230 provides an overall system for finding and displaying source code. Search engine 1228 provides search functions. File viewer 1232 provides a user interface to display source code. Project viewer 1234 provides a user interface to view a project in which source code may be found. Language information 1236, license information 1238 and repository information 1242 provide translation of language (Java, C, etc.), license data and repository code respectively.

Web API 1220 provides a web-based interface for access to website engine 1230. Search API 1216 provides a search interface. File and project information APIs 1218 and 1222 provide interfaces for information on specific files and related projects. Administrative API 1224 provides an interface for command access and maintenance. Reporting API 1226 provides an interface for report information, such as searches performed and code used/reused.

Client interface 1240 provides a client which can be used as a plug-in or a standalone application. User interface 1244 is a web-based interface. Windows client 1246 allows for use within a Windows operating system. Visual Studio plugin 1248 provides a plugin for Visual Studio development environments or similar development platforms. Eclipse plugin 1252 provides a similar interface for an Eclipse environment. Moreover, similar plugins may be used with other systems.

For administrative access, administrative interface 1250 is provided. This interface allows for access by someone with administrative privileges. Reporting of performance results may be provided through interface 1250, along with security reporting and analysis of performance, for example. Users 1260 may be expected to use client 1240, but qualified users may use administrative interface 1250.

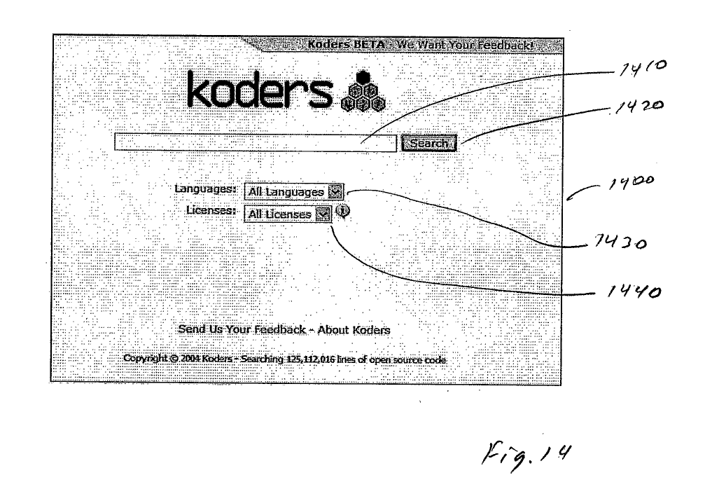

An alternative representation may also help illustrate the process. FIG. 13 illustrates another embodiment of a code search engine system. System 1300 provides a path for data through a system for a code search engine.

Source code 1310 is indexed, based on grammar files 1320 to form an AST tree 1330. AST tree 1330 is an abstract syntax tree, with internal nodes as operators and leaf nodes as operands. AST tree 1330 can be mapped to a code domain 1340, a representation of the source code which is presentable to users. Code domain XML file 1350 provides a format for code domain 1340. Viewer 1360 provides an interface to code domain 1340, allowing for export of data as HTML data 1370 or XML data 1380, for example.

With the various available representations of code, searches at various levels of abstraction may be accomplished. Thus, full text searching may occur. Syntactical analysis of code may be done, such that code with identical syntactical structure may be identified. Meta-data extraction may also be used, thereby allowing searching meta-data surrounding code for similar attributes.

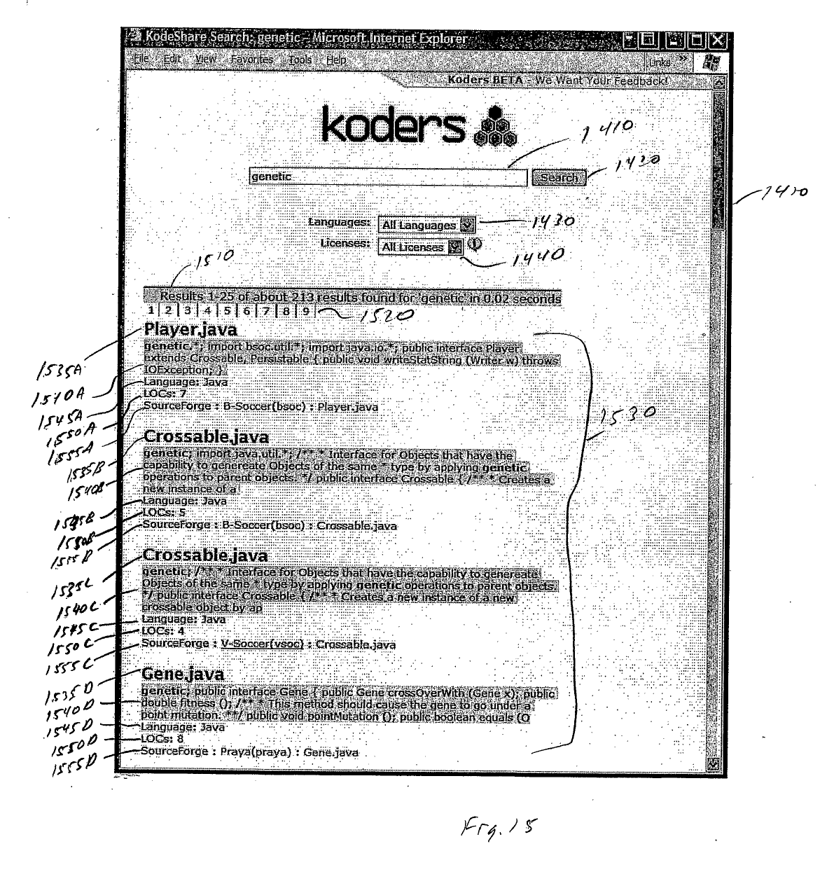

Various user interfaces may be used with implementations of code search engines. FIG. 14 illustrates an embodiment of a code search user interface. Interface 1400 provides a basic search interface which may be used as a website. Search box 1410 allows for entry of query criteria. Search button 1420 activates a search. Language selector 1430 allows for selection of a source code language. License selector 1440 allows for selection of a specific license, such as the GPL license, for example.

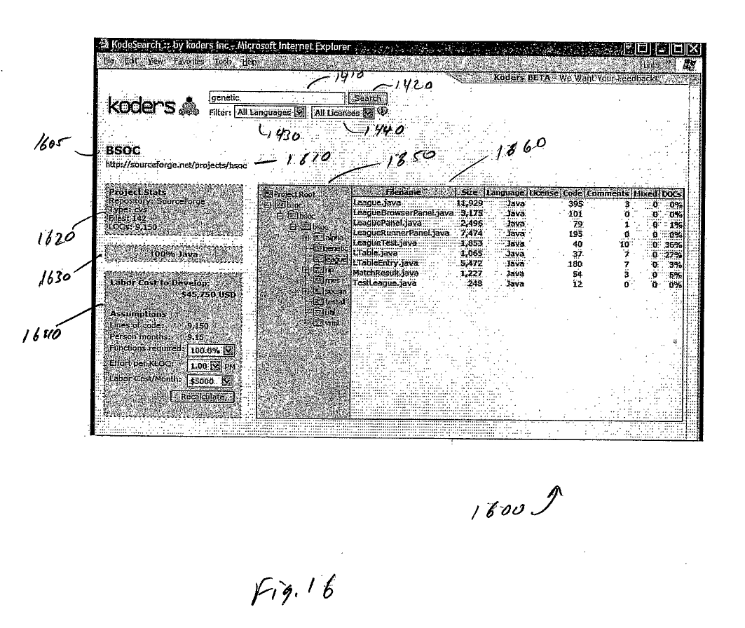

After a search, results are presented. FIG. 15 illustrates the embodiment of FIG. 14 showing search results. Results 1530 include a title 1535, API 1540, language 1545, lines of code 1550 and project source 1555 for each search result.

A project may also be accessed, either as part of a search result or as a development project. FIG. 16 illustrates an embodiment of a user interface for a code portion. User interface 1600 provides a title of a code portion 1605, website 1610, project status 1620, project type 1630, development cost 1640, project directory structure 1650 and project code portions listing 1660.

Features and aspects of various embodiments may be integrated into other embodiments, and embodiments illustrated in this document may be implemented without all of the features or aspects illustrated or described. One skilled in the art will appreciate that although specific examples and embodiments of the system and methods have been described for purposes of illustration, various modifications can be made. For example, embodiments of the present invention may be applied to many different types of databases, systems and application programs. Moreover, features of one embodiment may be incorporated into other embodiments, even where those features are not described together in a single embodiment within the present document. Accordingly, the invention is described by the appended claims.

1. A method, comprising:
receiving a search query for a software code search engine;
searching a software code database with the search query, the software code database populated with source code from one or more sources of source code; and
presenting results of the searching.

2. The method of claim 1, further comprising:
populating the software code database.

3. The method of claim 2, wherein:
the software code database is populated from a version control system.

4. The method of claim 2, wherein:
the software code database is populated from publicly available source code.

5. The method of claim 2, wherein:
the software code database is populated from a file system.

6. The method of claim 2, wherein:
the software code database is populated from a version control system and publicly available source code.

7. The method of claim 1, further comprising:
indexing software code of the software code database;
and wherein searching includes comparing the search query to an index of the software code database.

8. The method of claim 1, further comprising:
tracking reuse of code portions of the software code database.

9. The method of claim 1, further comprising:
reporting on usage of code portions of the software code database.

10. The method of claim 1, wherein:
the method is performed by a processor responsive to instructions embodied in a machine-readable medium.

11. The method of claim 1, further comprising:
populating the software code database from a code revision system;
indexing software code of the software code database;
and wherein searching includes comparing the search query to an index of the software code database.

12. The method of claim 11, further comprising:
tracking reuse of code portions of the software code database; and
reporting on usage of code portions of the software code database.

13. The method of claim 1, wherein:
searching includes searching for a full text match.

14. The method of claim 1, wherein:
searching the software code database includes searching for a syntactic match.

15. The method of claim 1, wherein:
searching the software code database includes searching for matching metadata associated with source code.

16. The method of claim 1, further comprising:
tracking reuse of code portions of the software code database; and
wherein presenting results of the searching includes presenting results in an order based on reuse statistics associated with the results.

17. The method of claim 16, further comprising:
reporting on reuse of code portions of the software code database.

18. The method of claim 1, further comprising:
populating the software code database from a public repository of source code;
indexing software code of the software code database;
tracking reuse of code portions of the software code database;
reporting on usage of code portions of the software code database; and
wherein searching includes comparing the search query to an index of the software code database.

19. A method of operating a software search engine, comprising:
populating a software code database;
receiving a search query for a software code search engine;
searching the software code database with the search query;
presenting results of the searching;
tracking reuse of code portions of the software code database; and
reporting on usage of code portions of the software code database.

20. The method of claim 19, wherein:
the software code database is populated from a code revision system.

21. The method of claim 19, wherein:
the software code database is populated from a public repository of source code.

22. A system, comprising:
a software code database;
a search engine coupled to the software code database; and
a user interface coupled to the search engine.

23. The system of claim 22, wherein:
the software code database is populated with software code from a public repository of source code.

24. The system of claim 22, wherein:
the software code database is populated with software code from a source code revision control system.

25. The system of claim 22, wherein:
the software code database is populated with software code from a public repository of source code and a source code revision control system.

26. The system of claim 22, wherein:
the user interface is part of a source code development application.

27. A computer program stored on a computer readable media and including computer program code software for implementing a method including:
receiving a search query for a software code search engine;
searching a software code database with the search query, the software code database populated with source code from one or more sources of source code; and
presenting results of the searching.

28. A computer program stored on a computer readable media and including computer program code software for implementing a method of operating a software search engine including:
populating a software code database;
receiving a search query for a software code search engine;
searching the software code database with the search query;
presenting results of the searching;
tracking reuse of code portions of the software code database; and
reporting on usage of code portions of the software code database.
